(19) United States
(12) Patent Application Publication
(10) Pub. No.: US 2006/0085508 A1
(43) Pub. Date: Apr. 20, 2006

(54) E-mail communication apparatus, attached-file updating apparatus, E-mail communication method, attached-file updating method, and E-mail communication program

(75) Inventors: Masanori Uchida, Kawasaki (JP); Masayoshi Tanigawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/036,333

(22) Filed: Jan. 18, 2005

(30) Foreign Application Priority Data
Oct. 18, 2004 (JP) 2004-303151

(51) Int. Cl. G06F 15/16

(52) U.S. Cl. 709/206

(57) ABSTRACT

An E-mail communication apparatus that edits files attached to an E-mail and transmits the E-mail. The apparatus comprises a mail generating unit, a temporary-file generating unit, a temporary-file editing unit, an attached-file updating unit, and a transmitting unit. The mail generating unit generates a mail which is to be transmitted and to which a file is attached. The temporary-file generating unit generates a temporary file by copying the file attached to the mail that is to be transmitted. The temporary-file editing unit calls an application associated with the file attached to the mail that is to be transmitted, edits the temporary file and updates the temporary file. The attached-file updating unit replaces the file attached to the mail that is to be transmitted, with the temporary file copied. The transmitting unit transmits the mail to be transmitted.

### BACKGROUND OF THE INVENTION

1. Field of the Invention

The present invention relates to an E-mail communication apparatus, an attached-file updating apparatus, an E-mail communication method, an attached-file updating method and an E-mail communication program, each designed to change and transmit the files that have been already prepared and attached to an E-mail.

2. Description of the Related Art

It will be described how a response mail having the same attached file as the one attached to a received E-mail is prepared, how the attached file is change and how an E-mail with the attached file changed is transmitted, by utilizing a mail application for transmitting and receiving E-mails and an edition application for editing attached files. For example, the attached file received may be a document having a response column, a check column, data items to be corrected and the like. In this case, the user who has received the E-mail writes a response, fills the check column and corrects the data items, and then transmits the E-mail back to the sender.

FIG. 3 is a block diagram illustrating an example of the configuration of a conventional E-mail communication apparatus. The E-mail communication apparatus is realized by a computer or the like. The apparatus incorporates a mail application 101, an edition application 2, and a data-storing unit 103. The data-storing unit 103 comprises a mail-storing region 11, a temporary data-storing region 12, and a file-storing region 113.

The mail application 101 transmits and receives mails to and from an external mail server. The mail application 101 stores mails received, in the mail-storing region 11, and acquires mails from the mail-storing region 11 so that the mails may be transmitted. The mail application 101 stores attached files in the file-storing region 113 and acquires the attached files from the file-storing region 113. Further, the mail application 101 stores any attached file in the temporary data-storing region 12 so that the attached file may be opened, and instructs the edition application 2 to open the attached file stored in the temporary data-storing region 12. When so instructed, the edition application 2 opens the attached file stored in the temporary data-storing region 12.

FIG. 4 is a flowchart showing a process that the conventional mail application performs to store attached files. The mail application first displays the content of an E-mail received (Step S51) and then stores the mail in a local storage device (Step S52), in accordance with the user's instruction. FIG. 5 is a flowchart depicting a process that the conventional edition application performs to edit the files attached to the E-mail. The edition application first opens any attached file designated by the user (Step S61), then edits the attached file (Step S62), and finally stores the attached file thus edited (Step S63). FIG. 6 is a flowchart illustrating a process that the conventional mail application to transmit an E-mail back to the sender. In accordance with the user's instruction, the mail application prepares an E-mail in response to the mail received (Step S71), selects an attached file changed, attaches the file to the E-mail (Step S72), edits the text of the E-mail (Step S73), and transmits the E-mail (Step S74).

It will be described how the content of the file attached to a mail received is displayed by utilizing the conventional mail application and the conventional edition application. First, the mail application displays the content of the mail received, in accordance with the user's instruction. Then, the mail application calls the edition application associated with the file attached to the mail. Next, the edition application opens the attached file. At this time, the attached file is stored in the temporary data-storing region of the mail application.

Jpn. Pat. Appln. Laid-Open Publication No. 2001-142801, for example, discloses a method of managing document history. In this method, the history of updating any file attached to an E-mail is displayed in the course of transmitting and receiving the E-mail (see pages 3-9 and FIG. 1 of the publication).

In order to change an attached file by using the conventional mail application, the user must manipulate the applications to save the attached file, activate the edition application, and attach the file to the response mail. This requires much time and labor on the part of the user. Once stored in the local storage device, any attached file may reduce the available storage capacity of the local storage device unless the user deletes the attached file from the local storage device. If the user performs over-write saving of any attached file changed, he or she may no longer be sure whether attached file has been changed or not.

In the conventional mail application, the attached file is automatically copied in the temporary data-storing region to display the attached file. The attached file thus copied remains stored in the temporary data-storing region. This may reduce the available storage capacity of the local storage device.

### SUMMARY OF THE INVENTION

The present invention has been made to solve the problem described above. An object of the invention is to provide an E-mail communication apparatus, an E-mail communication method and an E-mail communication program, each designed to achieve efficient changing of the files attached to an E-mail.

To attain the object mentioned above, the present invention provides an E-mail communication apparatus for editing files attached to an E-mail and transmitting the E-mail. The apparatus comprises: a mail generating unit that generates a mail which is to be transmitted and to which a file is attached; a temporary-file generating unit that generates a temporary file by copying the file attached to the mail that is to be transmitted; a temporary-file editing unit that calls an application associated with the file attached to the mail that is to be transmitted, edits the temporary file and updates the temporary file; and an attached-file updating unit that replaces the file attached to the mail that is to be transmitted, with the temporary file copied.

In the E-mail communication apparatus according to this invention, the mail generating unit acquires a file attached to the E-mail and uses the file as file attached to the mail that is to be transmitted.

In the E-mail communication apparatus according to the invention, the attached-file updating unit changes a file name of the file attached to the mail that is to be transmitted.

The E-mail communication apparatus according to the present invention may further comprise a temporary-file deleting unit that deletes the temporary file after the E-mail is transmitted.

Moreover, the present invention provides an attached-file updating apparatus which is designed for use in an E-mail communication apparatus for transmitting and receiving E-mails and which uses a temporary file generated as a copy of a file attached to a mail that is to be transmitted, when opening the file attached to the mail. The attached-file updating apparatus comprises: a temporary-file editing unit that calls an application associated with the file attached to the mail that is to be transmitted, edits the temporary file and updates the temporary file; and an attached-file updating unit that replaces the file attached to the mail that is to be transmitted, with the temporary file copied.

Further, the present invention provides an E-mail communication method that edits files attached to an E-mail and transmits the E-mail. The method comprises: a mail-generating step of generating a mail which is to be transmitted and to which a file is attached; a temporary-file generating step of generating a temporary file by copying the file attached to the mail that is to be transmitted; a temporary-file editing step of calling an application associated with the file attached to the mail that is to be transmitted, editing the temporary file and updating the temporary file; and an attached-file updating step of replacing the file attached to the mail that is to be transmitted, with the temporary file copied.

In the E-mail communication method according to this invention, in the mail-generating step, a file attached to the E-mail is acquired and used as file attached to the mail that is to be transmitted.

In the E-mail communication method according to the invention, a file name of the file attached to the mail that is to be transmitted is changed in the attached-file updating step.

The E-mail communication method according to this invention further comprises a temporary-file deleting step of deleting the temporary file after the E-mail is transmitted.

The present invention further provides an attached-file updating method which is designed for use in an E-mail communication apparatus for transmitting and receiving E-mails and which uses a temporary file generated as a copy of a file attached to a mail that is to be transmitted, when opening the file attached to the mail. The attached-file updating method comprises: a temporary-file editing step of calling an application associated with the file attached to the mail that is to be transmitted, editing the temporary file and updating the temporary file; and an attached-file updating step of replacing the file attached to the mail that is to be transmitted, with the temporary file copied.

This invention further provides an E-mail communication program that causes a computer to perform an E-mail communication method that edits files attached to an E-mail and transmits the E-mail. The program describes: a mail-generating step of generating a mail which is to be transmitted and to which a file is attached; a temporary-file generating step of generating a temporary file by copying the file attached to the mail that is to be transmitted; a temporary-file editing step of calling an application associated with the file attached to the mail that is to be transmitted, editing the temporary file and updating the temporary file; and an attached-file updating step of replacing the file attached to the mail that is to be transmitted, with the temporary file copied.

In the E-mail communication program according to the present invention, a file attached to the E-mail is acquired and used as file attached to the mail that is to be transmitted, in the mail-generating step.

In the E-mail communication program according to the present invention, a file name of the file attached to the mail that is to be transmitted is changed in the attached-file updating step.

The E-mail communication program according to the invention further describes a temporary-file deleting step of deleting the temporary file after the E-mail is transmitted.

Moreover, the present invention provides an attached-file updating program that causes a computer to perform, in an E-mail communication apparatus for transmitting and receiving E-mails, an attached-file updating method that uses a temporary file generated as a copy of a file attached to a mail that is to be transmitted, when opening the file attached to the mail. This program describes: a temporary-file editing step of calling an application associated with the file attached to the mail that is to be transmitted, editing the temporary file and updating the temporary file; and an attached-file updating step of replacing the file attached to the mail that is to be transmitted, with the temporary file copied.

The present invention can reduce the time and labor that the user must spend to save attached files, edit the attached files, attach files to E-mails or the like, and perform similar operations. The available storage capacity of the local storage device does not decrease because the attached files or the temporary files do not remain in the local storage device. Since the name of any attached file is changed every time the file is updated, the user can know that the attached file has been updated. Moreover, since temporary files generated by the conventional mail application are used, it suffices to add the function of this invention to the conventional mail application, thereby to achieve the present invention easily.

### BRIEF DESCRIPTION OF THE DRAWINGS

FIG. 1 is a block diagram showing an example of the configuration of an E-mail communication apparatus according to the present invention;

FIG. 2 is a flowchart showing an example of operation of the E-mail application according to this invention;

FIG. 3 is a block diagram depicting an example of the configuration of a conventional E-mail communication apparatus;

FIG. 4 is a flowchart showing an example of the process of saving an attached file, in a conventional E-mail application;

FIG. 5 is a flowchart showing an example of the process of editing an attached filed, in the conventional edition application;

FIG. 6 is a flowchart showing an example of the process of transmitting a response mail, in the conventional E-mail application.

### DETAILED DESCRIPTION OF THE PREFERRED EMBODIMENTS

An embodiment of the present invention will be described, with reference to the accompanying drawings.

It will be described how a response mail having the same attached file as the file attached to a received mail is prepared, how the attached file is changed and how the response mail is transmitted, as has been described above, by using an mail application for receiving and transmitting E-mails and an edition application for editing attached files.

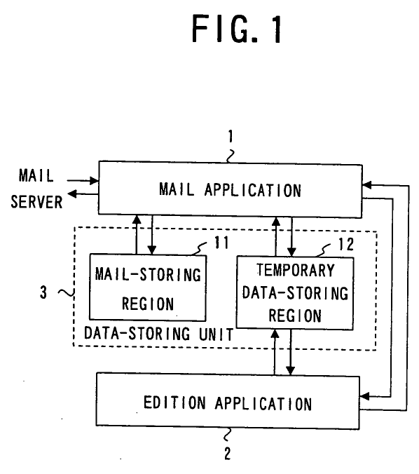

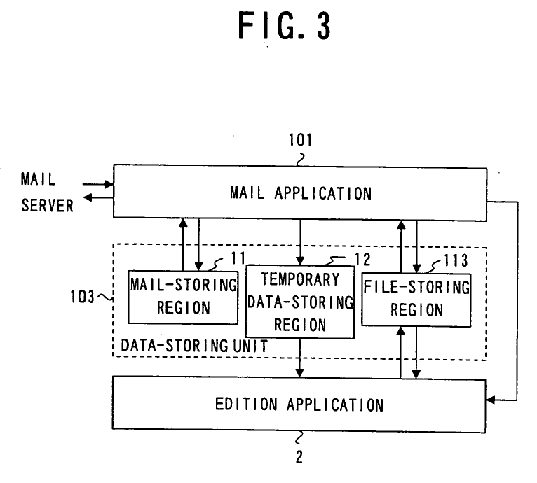

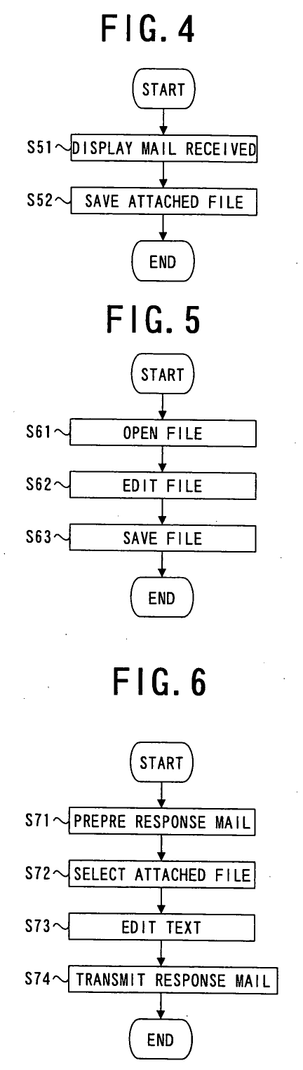

FIG. 1 is a block diagram showing an example of the configuration of an E-mail communication apparatus according to this invention. The components identical or equivalent to those shown in FIG. 3 are designated at the same reference numerals in FIG. 1 and will not be described in detail. The E-mail communication apparatus of FIG. 1 differs from the apparatus of FIG. 3 in that a mail application 1 and a data-storing unit 3 are used in place of the mail application 101 and data-storing unit 103, respectively. Unlike the data-storing unit 103, the data-storing unit 3 does not need the file-storing region 113.

Like the mail application 101, the mail application 1 transmits and receives mails to and from an external mail server. The mail application 1 saves mails received, in the mail-storing region 11, and acquires mails from the mail-storing region 11 so that the mails may be transmitted. Further, the mail application 1 stores copies of the attached files, as temporary files, in the temporary data-storing region 12, so that the attached files may be opened. Still further, the mail application 1 instructs the edition application 2 to open the temporary files stored in the temporary data-storing region 12. Moreover, the mail application 1 copies the temporary files stored in the temporary data-storing region 12 and stores the temporary files, as attached files, in the mail-storing region 11.

The edition application 2 opens the temporary file stored in the temporary data-storing region 12 and designated by the mail application 1, and then stores any temporary file that has been changed, in the temporary data-storing region 12.

The edition application 2 informs the mail application 1 that it has completed the process assigned to it.

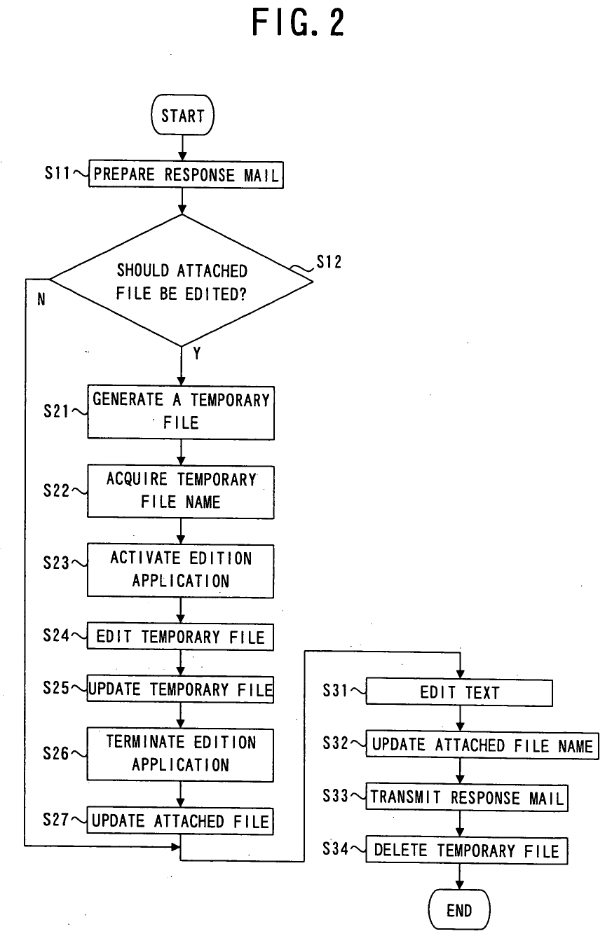

FIG. 2 is a flowchart showing an example of operation of performed by the E-mail application according to this invention. First, the mail application prepares a response mail on the basis of the mail received and having an attached file, when so instructed by a user (Step S11). The response mail thus prepared contains the attached file contained in the mail received. Next, the mail application determines whether the attached file should be edited or not, from the user's instruction (Step S12).

If the attached file need not be edited (if NO in Step S12), the operation goes to Step S31. If the attached file should be edited (if YES in Step S12), the mail application copies the attached file and stores the same as a temporary file in the temporary data-storing region (Step S21). Then, the mail application acquires a temporary-file name (Step S22). The temporary-file name is stored in, for example, the work file of the mail application. Next, the mail application activates the edition application and instructs the edition application to open the file having the temporary-file name acquired (Step S23). The edition application edits the temporary file in accordance with the user's instruction (Step S24). The edition application performs over-write saving on the temporary file changed. Thus, the temporary file is updated (Step S25). The edition application is then terminated (Step S26).

Upon receiving the notice showing the termination of the edition application, the mail application replaces an attached file of the E-mail with the copied temporary file, thus updating the file attached to the E-mail, on the basis of the name of the temporary file stored in the temporary data-storing region 12 (Step S27).

Next, the mail application edits the text of the response mail in accordance with the user's instruction (Step S31), updates the name of the attached file (Step S32), transmits the response mail (Step S33) and deletes the temporary file (Step S34). The mail application then terminates this flow. In Step S32, the name of the attached file is changed every time the attached file is updated. Assume that the original attached file has name “aaa.bbb.” Then, the file name changes to “aaa_{—}1.bbb” when the attached file is updated for the first time, to “aaa_{—}2.bbb” when the attached file is updated for the second time. That is, a new serial number is added to the file name every time the attached file is updated. This enables the user to know that the attached file has been updated, as he or she sees the name of the attached file.

In the present embodiment, the response mail is one that waits for any file attached to the mail received. Nonetheless, the present invention can be used to update files attached to any E-mail, such as a transferred mail having the files attached to the mail received and a new E-mail having attached files.

As described above, any temporary file updated is copied and used as an attached file and its name is changed. Only this function (Steps S22, S23, S27, S32 and S34) may be added to the conventional mail application. The function can be realized as, for example, a plug-in function of the mail application.

The E-mail communication apparatus according to the present invention can easily be adapted to computers that incorporate a mail application. The apparatus can therefore render the computers user-friendlier. The computers incorporating the mail application may include work stations, personal computers, personal digital Assistants (PDAs) and mobile telephones.

The present invention can provide a program, which is used as an E-mail communication program that causes the computer (i.e., the computer constituting the E-mail communication apparatus) to execute the various steps described above. The program can be stored in a computer-readable recording medium and executed by the computer that constitutes the E-mail communication apparatus. The computer-readable recording medium may be a portable storage medium such as a CD-ROM, a flexible disc, a DVD disc, an optomagneto disc or an IC card. Alternatively, the computer-readable recording medium may be a database holding computer programs or a data-transfer medium provided on a line.

It should be noted that the E-mail communication apparatus, E-mail communication method and E-mail communication program are mail applications in the embodiment of the invention. The application associated with an attached file is the edition application in the embodiment of the invention. The attached-file updating apparatus, attached-file updating method and attached-file updating program are the plug-in function in the embodiment of the invention.

The unit for generating mails to transmit and the step of generating mails to transmit are Step S11 in the embodiment. The unit for generating temporary files and the step of generating temporary files are Step S21 in the embodiment. The unit for editing temporary files and the step of editing temporary files are Steps S23, S24, S25 and S26 in the embodiment. The unit for updating attached files and the step of updating attached files are Steps S27 and S32 in the embodiment. The data-transmitting unit and data-transmitting step are Step S33 in the embodiment. The unit for deleting temporary files and the step of deleting temporary files are Step S34 in the embodiment.

What is claimed is:

1. An E-mail communication apparatus that edits files attached to an E-mail and transmits the E-mail, said apparatus comprising:
a mail generating unit that generates a mail which is to be transmitted and to which a file is attached;
a temporary-file generating unit that generates a temporary file by copying the file attached to the mail that is to be transmitted;
a temporary-file editing unit that calls an application associated with the file attached to the mail that is to be transmitted, edits the temporary file and updates the temporary file; and
an attached-file updating unit that replaces the file attached to the mail that is to be transmitted, with the temporary file copied.

2. The E-mail communication apparatus according to claim 1, wherein the mail generating unit further acquires a file attached to the E-mail and uses the file as file attached to the mail that is to be transmitted.

3. The E-mail communication apparatus according to claim 1, wherein the attached-file updating unit further changes a file name of the file attached to the mail that is to be transmitted.

4. The E-mail communication apparatus according to claim 1, further comprising a temporary-file deleting unit that deletes the temporary file after the E-mail is transmitted.

5. An attached-file updating apparatus which is designed for use in an E-mail communication apparatus for transmitting and receiving E-mails and which uses a temporary file generated as a copy of a file attached to a mail that is to be transmitted, when opening the file attached to the mail, said apparatus comprising:
a temporary-file editing unit that calls an application associated with the file attached to the mail that is to be transmitted, edits the temporary file and updates the temporary file; and
an attached-file updating unit that replaces the file attached to the mail that is to be transmitted, with the temporary file copied.

6. An E-mail communication method that edits files attached to an E-mail and transmits the E-mail, said method comprising:
a mail-generating step of generating a mail which is to be transmitted and to which a file is attached;
a temporary-file generating step of generating a temporary file by copying the file attached to the mail that is to be transmitted;
a temporary-file editing step of calling an application associated with the file attached to the mail that is to be transmitted, editing the temporary file and updating the temporary file; and
an attached-file updating step of replacing the file attached to the mail that is to be transmitted, with the temporary file copied.

7. The E-mail communication method according to claim 6, wherein, in the mail-generating step, a file attached to the E-mail is acquired and used as file attached to the mail that is to be transmitted.

8. The E-mail communication method according to claim 6, wherein a file name of the file attached to the mail that is to be transmitted is changed in the attached-file updating step.

9. The E-mail communication method according to claim 6, further comprising a temporary-file deleting step of deleting the temporary file after the E-mail is transmitted.

10. An attached-file updating method which is designed for use in an E-mail communication apparatus for transmitting and receiving E-mails and which uses a temporary file generated as a copy of a file attached to a mail that is to be transmitted, when opening the file attached to the mail, said method comprising:
a temporary-file editing step of calling an application associated with the file attached to the mail that is to be transmitted, editing the temporary file and updating the temporary file; and
an attached-file updating step of replacing the file attached to the mail that is to be transmitted, with the temporary file copied.

11. An E-mail communication program that causes a computer to perform an E-mail communication method that edits files attached to an E-mail and transmits the E-mail, said program describing:
a mail-generating step of generating a mail which is to be transmitted and to which a file is attached;
a temporary-file generating step of generating a temporary file by copying the file attached to the mail that is to be transmitted;
a temporary-file editing step of calling an application associated with the file attached to the mail that is to be transmitted, editing the temporary file and updating the temporary file; and
an attached-file updating step of replacing the file attached to the mail that is to be transmitted, with the temporary file copied.

12. The E-mail communication program according to claim 11, wherein, in the mail-generating step, a file attached to the E-mail is acquired and used as file attached to the mail that is to be transmitted.

13. The E-mail communication program according to claim 11, wherein a file name of the file attached to the mail that is to be transmitted is changed in the attached-file updating step.

14. The E-mail communication program according to claim 11, further describing a temporary-file deleting step of deleting the temporary file after the E-mail is transmitted.

15. An attached-file updating program that causes a computer to perform, in an E-mail communication apparatus for transmitting and receiving E-mails, an attached-file updating method that uses a temporary file generated as a copy of a file attached to a mail that is to be transmitted, when opening the file attached to the mail, said program describing:
a temporary-file editing step of calling an application associated with the file attached to the mail that is to be transmitted, editing the temporary file and updating the temporary file; and
an attached-file updating step of replacing the file attached to the mail that is to be transmitted, with the temporary file copied.
